(19) United States
(12) Patent Application Publication
(10) Pub. No.: US 2026/0227747 A1
(43) Pub. Date: Aug. 6, 2026

(54) Method for Evaluating Operational Safety of a Workstation

(71) Applicant: ABB Schweiz AG, Baden (CH)

(72) Inventors: Silke Klose, Bensheim (DE); Peter Weber, Limburgerhof (DE); Fan Dai, Zwingenberg (DE); Florian Stuhlenmiller, Ladenburg (DE)

(73) Assignee: ABB Schweiz AG, Baden (CH)

(21) Appl. No.: 19/398,381

(22) Filed: Nov. 24, 2025

Related U.S. Application Data
(63) Continuation of application No. PCT/EP2023/064185, filed on May 26, 2023.

(51) Int. Cl. G05B 9/02

(52) U.S. Cl. CPC G05B 9/02

(57) ABSTRACT

A method for evaluating the operational safety of a workstation includes determining an outer boundary of a hazard area; determining, from this outer boundary, based on a given criterion for the reach of a human, off-limits areas that humans are to be denied entry to in order to keep them from reaching into the hazard area; determining, from the given configuration of protective devices, rendered-safe areas that these protective devices render safe with respect to access to the hazard area; subtracting the rendered-safe areas from the off-limits areas, so that modified off-limits areas result; and determining, based at least in part on the modified off-limits areas, whether operation of the workstation with the given configuration of protective devices is safe.

### CROSS-REFERENCE TO RELATED APPLICATIONS

The instant application claims priority to International Patent Application No. PCT/EP2023/064185, filed May 26, 2023, which is incorporated herein in its entirety by reference.

### FIELD OF THE DISCLOSURE

The present disclosure generally relates to establishing workplace safety in an industrial setting with pieces of equipment that may pose a potential hazard to humans.

### BACKGROUND OF THE INVENTION

On an industrial factory floor, there are a lot of pieces of equipment that may create a potential hazard to humans. Therefore, there are hazard areas on the factory floor that humans must be prevented from entering.

In theory, the simplest solution would be to close the whole factory floor to human access. But then little, if any, productive work could be done. In practice, protective devices are installed to make certain areas accessible to humans while at the same time preventing these humans from coming into direct contact with the hazard. The required risk assessment and mitigation presently very much rely on the expertise of engineers and/or system integrators.

In particular, it is quite difficult to motivate trade-offs between conflicting goals, such as allowing a freer movement of humans on the factory floor on the one hand and avoiding an exorbitant cost for a full, all-sides encapsulation of each and every piece of hazardous equipment.

Also, it is to be assumed that more and more new users of potentially hazardous machinery have only little, if any, knowledge in systematic hazard identification and proper risk reduction design.

### BRIEF SUMMARY OF THE INVENTION

The present disclosure generally describes a method for evaluating the operational safety of a workstation that is objective and does not rely on human experience anymore.

In one embodiment, the disclosure describes a method for evaluating the operational safety of a workstation. This workstation comprises at least one piece of equipment that creates a hazard area in its immediate surroundings. The hazard area is an area where a hazard created by the piece of equipment has a potential of harming a human when venturing into this hazard area with a susceptible body part.

The workstation further comprises a given configuration of one or more protective devices that are configured to prevent interaction between humans and the hazard. For example, such interaction may be prevented by inhibiting and/or detecting attempts of humans to access the hazard area. In the latter case, for example, the piece of equipment may be stopped or shut off, or an alarm may be sounded, in response to detecting an attempt to access the hazard area. But protective devices may also, for example, shield a human from hazards, such as laser radiation or ionizing radiation.

During the method, an outer boundary of the hazard area is determined. That is, it is determined where a human may venture at most with a body part without incurring a risk of harm by the hazard. For every hazard in industrial use, it is known how to determine the outer boundary of the hazard area. For example, in the case of a moving piece of equipment creating a mechanical hazard, all areas that may be reached by any part of the moving piece of equipment make up the hazard area. Thus, the outer boundary of the hazard area may be calculated in a straight-forward manner. In another example, in the case of laser radiation or ionizing radiation, it is known how this radiation propagates, and maximum exposure limits for humans are known as well. Thus, it may be calculated in a straight-forward manner where in space these maximum exposure limits may be exceeded. In yet another example, if the hazard comprises electrically energized parts, the hazardous area around these energized parts can be directly derived from relevant safety norms.

From the outer boundary, based on a given criterion for the reach of a human, off-limits areas that humans are to be denied entry to in order to keep them from reaching into the hazard area are determined. For example, there are ISO standards (such as ISO 13855 and ISO 13857) that define how far a human standing at a given position is deemed to be able to reach out. That is, starting from the outer boundary, it is determined in a geometric manner where a human needs to stand in order to be just able to reach into the hazard area. These locations, and all locations that are even closer to the hazard area, form the off-limits areas.

As discussed above, in theory, complete operational safety could be achieved by just closing off human access to all of the off-limits areas. But in a practical industrial setting, this would be more than likely to close off too much of the factory floor, so it would be no longer possible to perform the intended work. Therefore, a configuration of protective devices is used. From this given configuration of protective devices, rendered-safe areas that these protective devices render safe with respect to access to the hazard area are determined. This means that the rendered-safe areas can be safely used by humans. They can be “reclaimed” from the hazard. Therefore, they are subtracted from the off-limits areas, so that modified off-limits areas result.

Based at least in part on the so-determined modified off-limits areas, it is determined whether operation of the workstation with the given configuration of protective devices is safe. This may be determined by any suitable criterion, depending on the type of hazard involved.

The disclosed method is based purely on objective and readily available information, namely the outer boundary of the hazard area, geometric considerations as to where a human can reach, the effect of used protective devices, and the given criterion for determining whether operation is to be deemed safe, given the modified off-limits areas.

Therefore, safety can be evaluated in a purely objective and also automated manner. The result is independent from any expertise of a safety engineer or system integrator. Moreover, the automated determination allows to test a large set of candidate configurations of protective devices as to whether such a configuration renders the operation of the workstation safe, and also as to whether such a configuration is optimal with respect to any optimization goal that may be relevant on that factory floor. This is advantageous because some of the variables involved in the configuration of the protective devices are discrete variables that are not suitable for application of many numerical optimization methods. For example, a protective device may either be present or not, but it may not be “present with a degree of 0.6 on a scale between 0 and 1”. Thus, the problem of finding a configuration of protective devices that is optimal with respect to a particular goal may become a “mixed integer” problem that is hard to solve with numerical optimization. Rather, the testing of many possible configurations may be required.

### BRIEF DESCRIPTION OF THE SEVERAL VIEWS OF THE DRAWING(S

FIG. 1 is a flowchart for a method 100 for evaluating operational safety of a workstation in accordance with the disclosure.

FIG. 2 is a diagram of the effect of protective devices 3 on the off-limits areas 4 in accordance with the disclosure.

### DETAILED DESCRIPTION OF THE INVENTION

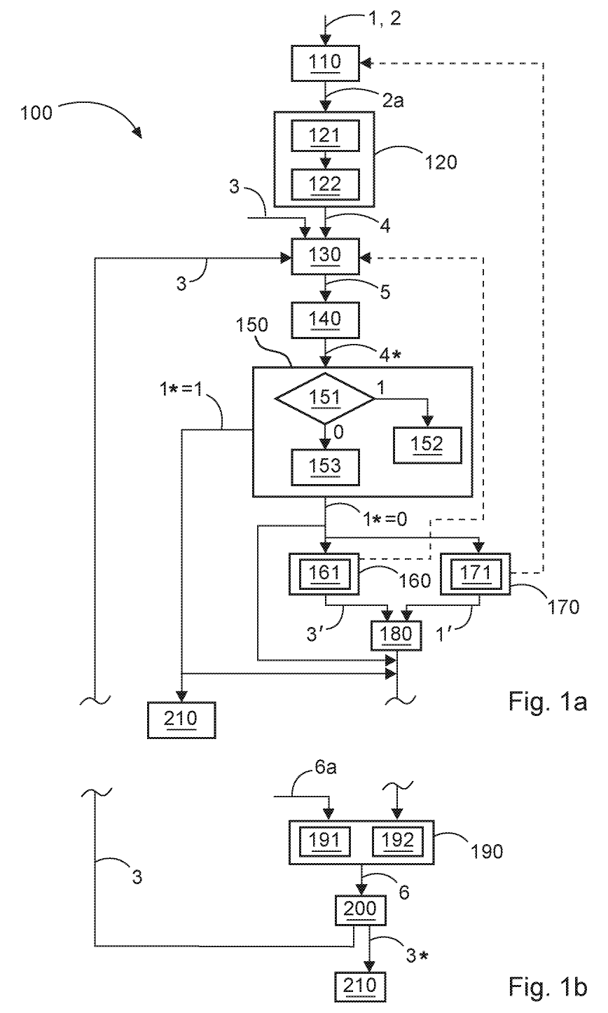

FIG. 1 is a schematic flow chart of an embodiment of the method 100 for evaluating the operational safety of a workstation with at least one piece of equipment 1. The piece of equipment 1 creates a hazard area 2 in its immediate surroundings. The workstation further comprises a given configuration of one or more protective devices 3. The protective devices 3 are configured to prevent interaction between humans and the hazard posed by the piece of equipment 1. That is, the combination of a piece of equipment 1 and the protective devices 3 preventing access to its hazard can be viewed as a “workstation” without requiring a physical connection between these entities.

In step 110, an outer boundary 2a of the hazard area 2 is determined. As discussed before, for every known hazard, there is a straight-forward manner of computing the outer boundary 2a. In step 120, from the outer boundary 2a, based on a given criterion for the reach of a human, off-limits areas 4 that humans are to be denied entry to in order to keep them from reaching into the hazard area 2 are determined. As discussed before, for example, ISO standards that define the reach of a human may be used for this purpose.

According to block 121, a geometrical shape that represents a human may be swept along the outer boundary 2a of the hazard area 2. According to block 122, the union of all so-obtained instances of the geometrical shape may then be determined as an off-limits area 4. In step 130, from the given configuration of protective devices 3, rendered-safe areas 5 that these protective devices 3 render safe with respect to access to the hazard area 2 are determined. These areas 5 can be “reclaimed” from the hazard in the sense that if a person can safely be there without being able to come into contact with the hazard in the hazard area 2. Consequently, in step 140, the rendered-safe areas 5 are subtracted from the off-limits areas 4, so that modified off-limits areas 4* result.

In step 150, based at least in part on the modified off-limits areas 4*, it is determined whether operation of the workstation with the given configuration of protective devices 3 is safe. The result 1* is a truth value of 0 (false) or 1 (true).

In particular, according to block 151, it may be determined whether humans have the opportunity to enter at least one modified off-limits area 4*. If this is the case (truth value 1), according to block 152, it may be determined that operation of the workstation is unsafe. By contrast, if humans have no opportunity to enter any modified off-limits area 4*, according to block 153, it may be determined that operation of the workstation is safe.

If it is determined that the operation of the workstation is not safe (truth value 1*=0), in step 160, the configuration of protective devices 3 may be modified. The result comprises new or modified protective devices 3'. Alternatively, or in combination to this, in step 170, the operation of the piece of equipment 1 may be modified to shrink the hazard area 2. The result is a modified operation 1'. Either way, based on the modified configuration of protective devices 3', and/or on the modified operation 1' of the piece of equipment 1, it may be re-evaluated, in step 180, whether operation of the workstation is safe.

According to block 161, the modifying of the configuration of protective devices 3 may comprise adding a protective device 3 that renders safe at least part of a modified off-limits area 4* that humans have an opportunity to enter. As discussed before, in this manner, the improvement of protection may be targeted at areas where it is presently weak.

According to block 171, the modifying of the operation of the piece of equipment 1 may comprise limiting a range of motion of the piece of equipment 1, so as to shrink a mechanical hazard area 2.

In the example shown in FIG. 1, in step 190, for the configuration of protective devices 3, a figure of merit 6 may be computed according to a predetermined criterion 6a. In step 200, the configuration of protective devices 3 may then be optimized towards the goal of improving the figure of merit 6 under the constraint that operation of the workstation with the configuration is determined to be safe.

According to block 191, the predetermined criterion 6a may comprise at least: a total size of a factory floor with the workplace that remains accessible to humans given the configuration of protective devices 3 and the requirement to prohibit entry to modified off-limits areas; and/or a total cost of the protective devices 3.

According to block 192, in the figure of merit 6, the accessibility to humans of at least one first area on the factory floor with the workplace may have a higher weight than the accessibility of at least one second area on this factory floor. As discussed before, from a practical point of view, the reclaiming of some areas on the factory floor may be worth more than the reclaiming of other areas.

Irrespective of whether the operation of the workstation is deemed to be safe right from the start or whether the safe state is the result of an optimization, in step 210, the workstation may be actuated to start the operation with the safe configuration of protective devices 3.

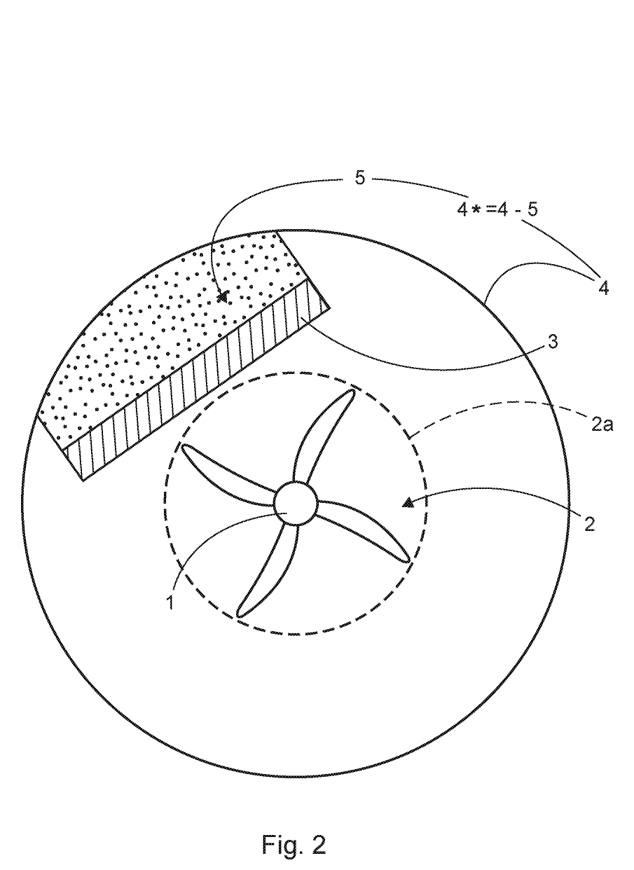

FIG. 2 illustrates the concept of reclaiming space for access to humans by introducing protective devices 3. FIG. 2 is a top view of a factory floor where a piece of equipment 1 is operating. The piece of equipment 1 comprises fast-moving mechanical parts that create a hazard area 2 with an outer boundary 2a. Around this outer boundary 2a, there is an off-limits area 4. Any person in this off-limits area 4 could potentially reach into the hazard area 2 and get injured. Therefore, access of humans to the off-limits area 4 must be prevented. This may render a rather large area on the factory floor inaccessible. But if a protective device 3 is introduced, this renders safe an area 5. In the example shown in FIG. 2, the protective device 3 is a barrier that blocks access of humans standing in the rendered-safe area 5 to the hazard area 2. Therefore, people in this area 5 are no longer in danger, and the area 5 is “reclaimed” for human use.

In a particularly advantageous embodiment, while determining whether the operation of the workstation is safe, it may be determined whether humans can enter at least one modified off-limits area. If this is the case, it is then determined that operation of the workstation is unsafe. By contrast, if humans have no opportunity to enter any modified off-limits area, it is determined that operation of the workstation is safe. This is a suitable criterion for hazards that can cause harm even on a single momentary contact, such as the fast motion of mechanical parts with great force. There may be other hazards for which a more relaxed criterion is suitable. For example, the impact of laser or ionizing radiation may be tolerable for a certain amount of time.

In a further particularly advantageous embodiment, in response to determining that the operation of the workstation is not safe, the configuration of protective devices is modified. Alternatively, or in combination to this, the operation of the piece of equipment may be modified so as to shrink the hazard area. Based on the modified configuration of protective devices, and/or on the modified operation of the piece of equipment, it is re-evaluated whether operation of the workstation is safe. In this manner, starting from an unsafe state, a safe state may be found in a fully automated manner without requiring any prior knowledge of safety design.

In particular, the modifying of the configuration of protective devices may comprise adding a protective device that renders safe at least part of a modified off-limits area that humans have an opportunity to enter. That is, in the form of these modified off-limits areas, the evaluation of the safety already gives an indication where the safety problem lies. The modification before the re-evaluation can thus be performed in a targeted manner.

In particular, the modifying of the operation of the piece of equipment may comprise limiting a range of motion of the piece of equipment, so as to shrink a mechanical hazard area. For example, the full range of motion of a robot or other mechanical equipment might only be needed during a small portion of the overall working time, whereas a limited range of motion might suffice for most of the time. In this situation, an area that is off-limits when the full range of motion is needed may become usable for humans for most of the time when only the limited range of motion is needed. This allows for a more efficient space usage on the factory floor.

In a further particularly advantageous embodiment, a figure of merit is computed for the configuration of protective devices according to a predetermined criterion. The configuration of protective devices is optimized towards the goal of improving the figure of merit under the constraint that operation of the workstation with the configuration is determined to be safe. That is, given an optimization goal, the best safe solution with respect to this optimization goal may be determined. Multiple optimization goals, such as efficient space utilization versus cost for protective devices, may be weighed against one another in the figure of merit. On the way to the optimal solution, it is not required that each candidate solution considered by the optimization algorithm must be a safe one. Rather, for example, the optimization algorithm may also proceed through solutions that are optimal with respect to the given goal but not yet safe and then find a closest safe solution.

As discussed before, in one example, the predetermined criterion may comprise a total size of a factory floor with the workstation that remains accessible to humans given the configuration of protective devices and the requirement to prohibit entry to modified off-limits areas. This means that, given a fixed quantity of factory floor, more workstations may be installed. Alternatively, or in combination to this, the predetermined criterion may comprise a total cost of the protective devices. Both conflicting goals may be weighed against each other in order to arrive at an optimal trade-off. For example, starting from a state with no protective devices, installation of the first protective devices can be expected to bring a large gain in “reclaimed” space that can be made accessible to humans per unit cost. Later, there may come a point where the installation of still further protective devices costs disproportionally more per unit of “reclaimed” space.

In another particularly advantageous embodiment, in the figure of merit, the accessibility to humans of at least one first area on the factory floor with the workplace may have a higher weight than the accessibility of at least one second area on this factory floor. In this manner, it may be reflected in the optimization goal that “reclaiming” certain crucial space may be much more valuable than “reclaiming” other space. For example, the availability of a certain space on the factory floor may be decisive as to whether another workstation can fit onto the factory floor or not.

One example of a protective device is a barrier that prevents movement of a human body and/or body part towards the hazard area. For example, the barrier may be a fence or mesh that allows a human to watch the operation of the piece of equipment, but not to reach a hand through.

In another example, the protective device may be a shield that prevents a hazard emanating from the hazard area from reaching a human body. For example, a barrier may be configured as an optical filter that blocks a laser wavelength, or it may comprise materials that shield ionizing radiation.

In yet another example, the protective device may be a sensor that detects movement of a human body and/or body part towards the hazard area and is interlocked with the piece of equipment. Interlocking may mean that the piece of equipment is stopped or shut off if movement towards the hazard area is detected. Such a protective device can be considered a “soft barrier” that does not obstruct the view to the piece of equipment and does not take up much physical space, but effectively prevents a human from encountering the hazard nonetheless. If the piece of equipment cannot be stopped or shut off instantaneously, but rather takes time to stop or shut off, this time needs to be factored in in the placement of the sensor. I.e., starting from the moment of detecting movement towards the hazard area, the piece of equipment needs to be stopped or shut off before a body part of the human reaches the hazard area.

A laser scanner as a sensor may be re-configured on-the-fly for monitoring different areas. That is, in a first operating situation where the hazard area has a first size, the laser scanner may detect attempts of the humans to reach through a safety line at a first position on the factory floor. But in a second operating situation where the hazard area has a second, smaller size, the safety line may be moved closer to the piece of equipment, so as to reclaim even more space for human access.

One example of a potentially hazardous piece of equipment comprises a robot whose motion creates a mechanical hazard area. A robot may move at a great speed and with great force. Therefore, it may cause massive damage when colliding with a human.

Where the robot is mounted on a carrier, such as a table, this has multiple effects. First, the carrier shifts the area in which the robot might move. For example, if the robot is on top of a table, the area that is reachable by the robot is shifted upwards. Second, the carrier creates areas in which humans cannot stand. For example, a table acts somehow like a barrier. The presence of a carrier allows for a more refined computation of the hazard area. For example, if a robot is located on a table as a carrier with varying geometries and heights, a volume swept by the robot may be divided into sub-volumes associated with the different table segments and then expanded according to the table segment properties. In this manner, the hazard area may extend outwards from the robot for less than the theoretical maximum safety distance.

Another example of a potentially hazardous piece of equipment is a radioactive source that creates a radiation hazard area. This hazard area is defined primarily by a distance towards the source, since the source typically emits the radiation in all directions. The intensity of the radiation decays with the square of the distance.

Yet another example of a potentially hazardous piece of equipment is electrical equipment whose energized parts create an electrical hazard area. The size of the hazard area is given in established standards as a function of the voltage of the energized parts.

In a particularly advantageous embodiment, in the course of determining off-limits areas, a geometrical shape that represents a human is swept along the outer boundary of the hazard area. At every point of this sweep, an instance of the geometrical shape is created. The union of all so-obtained instances of the geometrical shape is determined as an off-limits area. In this manner, the off-limits area can be determined using purely geometrical considerations. A dynamic model of a human is not required. For example, said ISO standards model a human as a cylinder.

In a further particularly advantageous embodiment, in response to determining that operation of the workstation with the given configuration of protective devices is safe, the workstation is actuated to start the operation. In this manner, the validated safe operation of the workstation is put into practice, so that the workers on the factory floor actually benefit from the validated safety.

Because it is computer-implemented, the present method may be embodied in the form of a software. The invention therefore also relates to a computer program with machine-readable instructions that, when executed by one or more computers and/or compute instances, cause the one or more computers and/or compute instances to perform the method described above. Examples for compute instances include virtual machines, containers or serverless execution environments in a cloud. The invention also relates to a machine-readable data carrier and/or a download product with the computer program. A download product is a digital product with the computer program that may, e.g., be sold in an online shop for immediate fulfilment and download to one or more computers. The invention also relates to one or more compute instances with the computer program, and/or with the machine-readable data carrier and/or download product.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

List of reference signs:

1 piece of equipment

1' modified operation of piece of equipment 1

1* safety of operating workstation

2 hazard area around piece of equipment 1

2a outer boundary of hazard area

3 protective devices

3' new or modified protective devices

4 off-limits areas

4* modified off-limits areas

5 areas rendered safe by protective devices 3

6 figure of merit

6a criterion for figure of merit

100 method for evaluating operational safety

110 determining outer boundary 2a of hazard area 2

120 determining off-limits areas 4

121 sweeping geometrical shape along outer boundary 2a

122 determining off-limits area as union of geometrical shape instances

130 determining rendered-safe areas 5

140 subtracting rendered-safe areas 5 from off-limits areas 4

150 determining whether operation of the workstation is safe

151 determining whether humans can enter modified off-limits areas 4*

152 determining that operation of workstation is unsafe

153 determining that operation of workstation is safe

160 modifying configuration of protective devices 3

161 adding protective device that renders problematic area safe

170 modifying operation of piece of equipment 1

171 limiting range of motion of piece of equipment 1

180 re-evaluating whether operation of workstation is safe

190 computing figure of merit 6

191 special choices for criterion 6a

192 differently weighting factory floor areas

200 optimizing configuration of protective devices 3

210 actuating workstation to start operation deemed to be safe

What is claimed is:

1. A method for evaluating the operational safety of a workstation, wherein the workstation comprises at least one piece of equipment that creates a hazard area in its immediate surroundings, and further comprises a given configuration of protective devices configured to prevent interaction between humans and the hazard, comprising:
determining an outer boundary of the hazard area;
determining from the outer boundary, based on a given criterion for the reach of a human, off-limits areas that humans are to be denied entry to in order to keep them from reaching into the hazard area;
determining, from the given configuration of protective devices, rendered-safe areas that the protective devices render safe with respect to access to the hazard area;
subtracting the rendered-safe areas from the off-limits areas so that modified off-limits areas result; and
determining, based at least in part on the modified off-limits areas, whether operation of the workstation with the given configuration of protective devices is safe.

2. The method of claim 1, wherein determining whether the operation of the workstation is safe comprises:
determining whether humans can enter at least one modified off-limits area; and
when true, determining that operation of the workstation is unsafe; and
when false, determining that operation of the workstation is safe.

3. The method of claim 2, further comprising: in response to determining that the operation of the workstation is unsafe, modifying the configuration of protective devices, and/or modifying operation of the piece of equipment to shrink the hazard area; and re-evaluating, based on the modified configuration of protective devices, and/or on the modified operation of the piece of equipment, whether operation of the workstation is safe.

4. The method of claim 3, wherein modifying of the configuration of protective devices comprises adding a protective device that renders safe at least part of a modified off-limits area that humans have an opportunity to enter.

5. The method of claim 3, wherein modifying the operation of the piece of equipment comprises limiting a range of motion of the piece of equipment to shrink a mechanical hazard area.

6. The method of claim 1, further comprising computing, for the configuration of protective devices, according to a predetermined criterion, a figure of merit; and optimizing the configuration of protective devices towards the goal of improving the figure of merit under the constraint that operation of the workstation with the configuration is determined to be safe.

7. The method of claim 6, wherein the predetermined criterion comprises at least a total size of a factory floor with the workplace that remains accessible to humans given the configuration of protective devices and the requirement to prohibit entry to modified off-limits areas; and/or a total cost of the protective devices.

8. The method of claim 7, wherein accessibility to humans of at least one first area on the factory floor with the workplace has a higher weight than the accessibility of at least one second area on this factory floor.

9. The method of claim 1, wherein the protective devices comprise one or more of a barrier that prevents movement of a human body and/or body part towards the hazard area; a shield that prevents a hazard emanating from the hazard area from reaching a human body; and/or a sensor that detects movement of a human body and/or body part towards the hazard area and is interlocked with the piece of equipment.

10. The method of claim 1, wherein the piece of equipment comprises one or more of a robot whose motion creates a mechanical hazard area, a radiation source that creates a radiation hazard area, and electrical equipment whose exposed energized parts create an electrical hazard area.

11. The method of claim 1, wherein determining off-limits areas comprises sweeping a geometrical shape that represents a human along the outer boundary of the hazard area; and determining the union of all so-obtained instances of the geometrical shape as an off-limits area.

12. The method of claim 1, further comprising actuating the workstation to start the operation in response to determining that operation of the workstation with the given configuration of protective devices is safe.

13. A computer program, comprising machine-readable instructions that, when executed on one or more computers and/or compute instances, cause the one or more computers and/or compute instances to perform a method for evaluating the operational safety of a workstation, wherein the workstation comprises at least one piece of equipment that creates a hazard area in its immediate surroundings, and further comprises a given configuration of protective devices configured to prevent interaction between humans and the hazard, comprising:
instructions for determining an outer boundary of the hazard area;
instructions for determining from the outer boundary, based on a given criterion for the reach of a human, off-limits areas that humans are to be denied entry to in order to keep them from reaching into the hazard area;
instructions for determining, from the given configuration of protective devices, rendered-safe areas that the protective devices render safe with respect to access to the hazard area;
instructions for subtracting the rendered-safe areas from the off-limits areas so that modified off-limits areas result; and
instructions for determining, based at least in part on the modified off-limits areas, whether operation of the workstation with the given configuration of protective devices is safe.
